(19) United States
(12) Patent Application Publication
(10) Pub. No.: US 2007/0077802 A1
(43) Pub. Date: Apr. 5, 2007

(54) Electrical connector assembly

(76) Inventors: Bruno Dupont, Paris (FR); Francois Jodon, Saint Cloud (FR); Jean-Pierre Picaud, Eaubonne (FR)

Correspondence Address: BARLEY SNYDER, LLC, 1000 WESTLAKES DRIVE, SUITE 275, BERWYN, PA, 19312, US

(21) Appl. No.: 11/351,810

(22) Filed: Feb. 10, 2006

(30) Foreign Application Priority Data
Oct. 2, 2005 (EP) 05 290 305.1

(51) Int. Cl. H01R 13/64

(52) U.S. Cl. 439/247

(57) ABSTRACT

An electrical connector assembly including a first and a second connector, the first connector including a terminal unit and a housing having a wall section, where the terminal unit protrudes from the wall section enabling the first connector to be mated with the second connector. The terminal unit is movable with respect to the wall section. In a first state, the terminal unit protrudes from the wall section. In a second state, the terminal unit is lowered under, or aligned with the wall section.

### FIELD OF THE INVENTION

The present invention relates to an electric connector assembly comprising a first and a second connector, the first connector comprising a terminal unit and a housing having a wall section, the terminal unit protruding from the wall section enables the first connector to be mated with the second connector.

### BACKGROUND

From the prior art an electrical connector assembly of the above-mentioned type is known. A protruding terminal unit of the first connector is inserted into a cavity of the second connector through a cavity opening. A cover initially fitting in the cavity opening in a sealing manner is pushed into the cavity. Terminals provided at the outside of the terminal unit come slidingly into contact with terminals of the second connector within the cavity. In the mated position of both connectors the terminal unit fits in the cavity opening in a sealing manner.

The inside of the cavity is well protected from damaging mechanical influences as well as from dirt and moisture. However, it is difficult to protect the first connector in the same manner from environmental influences, e.g. mechanical influences. Providing a protective cover over the first connector would be a possibility but worsens the practicability of mating and unmating the connectors. Each time the connectors are to be mated the protective cover has to be removed and stored in a separate place, and vice versa for the unmating process. A further drawback is that the protective cover can be lost so that the first connector is fully subjected to environmental influences.

It is an object of the present invention to provide an electrical connector assembly with which a secure electrical connection can be realized and which is well protected.

### SUMMARY

According to the present invention an electrical connector assembly.

By moving the terminal unit the first connector can be varied between one state, in which it has a suitable plug profile, and another state, in which the pluggable profile is withdrawn. In the second state the terminal unit is in a protected position, especially with respect to damage due to mechanical influences, and with respect to the worst of the dirt. In the first state of the terminal unit the first connector is matable with the second connector.

In a preferred embodiment the first connector may comprise a passage through which the terminal unit extends in the first state and which is sealingly covered if the terminal unit is in the second state. In the second state the terminal unit is protected from the influence of aggressive environments, i.e. from the influence of dirt and moisture so that it remains clean. This also applies to terminals of the terminal unit so that they can make a good electrical contact with a respective counter terminal.

In an improved embodiment the first connector may comprise a passage through which the terminal unit extends in a sealed manner in the first state. This protects an area in the inside of the first connector from being effected by aggressive environments, e.g. dirt and moisture, via a way between the terminal unit and the passage, if the terminal unit is in its first state.

The second connector may comprise an opening through which the terminal unit extends in a sealed manner when the connectors are in a mated position. In an advantageous embodiment of the present invention the terminal unit may comprise a surrounding wall extending through the passage and the opening in a sealed manner, respectively. In this way, inside areas of both connectors are protected from being effected by aggressive environments, e.g. dirt and moisture, via a way between the terminal unit and the respective passage or opening. The surrounding wall may connect both inside areas while they are nevertheless protected in the described manner.

In a further enhanced embodiment the first connector may comprise a protection room in which the terminal unit is received in the first state with the protection room being sealed against an outside of the first connector when the terminal unit is in the first state. This fully protects the terminal unit from the influence of an aggressive environment, e.g. from the influence of dirt and moisture. The terminal unit remains clean which also applies to its at least one terminal wherein with the terminal unit a good electrical connection can be realised if needed.

In a preferred embodiment of the present invention the protection room may be sealed against the outside when the terminal unit is in the second state. In this way the protection room is also keep free from the influence of an aggressive environment, e.g. from dirt and moisture, in the second state of the terminal unit. The terminal unit can return to a clear protection room and remains clean in it.

In a further improved embodiment the first connector may comprise a drive arrangement being capable of moving terminal unit relative to the wall section. The first connector can be brought form a pluggable state into a non-pluggable state and vice versa by means of the drive arrangement.

In an advantageous embodiment of the present invention the movement of the terminal unit may be effected via the drive arrangement during a relative mating movement of the first and second connector. The terminal unit is brought into its first state just when it is needed for plugging into the second connector, i.e. when both connectors approach each other.

In a further improved embodiment the drive arrangement is capable of transforming the relative mating movement of the first and second connectors into the movement of the terminal unit relative to the wall section. In this way the movement of the first and second connectors is used for moving the terminal unit.

In a beneficial embodiment of the present invention the drive arrangement may comprise a lever mechanism driven by an electrical motor means, a pneumatic actuator mechanism, a hydraulic actuator mechanism or the second connector, especially during a relative mating movement of the first and second connectors. Herewith the movement of the terminal unit is realised in an easy manner wherein the movement is just carried out when it is needed, for example when both connectors approach each other.

In a preferred embodiment the second connector may comprise an activation finger protruding from the second connector in a mating direction towards the first connector wherein the activation finger drives the lever mechanism. Herewith the lever mechanism is operated in an easy manner and the terminal unit is only moved if a second connector corresponding to the first connector is approached relative to the first connector.

In an enhanced embodiment the second connector may comprise a counter terminal unit capable of being engaged with the terminal unit of the first connector in an inside of the second connector. In this way the electrical connection of both connectors is made in a protected area which especially protects with respect to mechanical influences and the worst of the dirt.

In an advantageous-embodiment the second connector may comprise a counter terminal unit capable of being engaged with the terminal unit of the first connector from a direction traverse a mating direction of the connectors. In this manner the electrical connection between the counter terminal unit and the terminal unit can be made independent from the construction of a leading section of the terminal unit when seen in the mating direction.

In a preferred embodiment the counter terminal unit may be capable of engaging with the terminal unit in a pincer-like manner. The pincer-like manner allows an easy realisation of engaging the terminal unit from the direction traverse the mating direction, and allows grasping behind a leading section of the terminal unit seen in the mating direction.

In an enhanced embodiment the counter terminal unit may comprise at least one rotatable jaw capable of engaging the terminal unit in a rotating movement, and / or may comprise at least one jaw capable of engaging the terminal unit in a translational movement. In this way the movement of engaging the terminal unit, e.g. from a direction traverse the mating direction, is realised.

In a preferred embodiment the jaw may comprise a drive lever wherein a force applied to the drive lever rotates the jaw. By means of the lever the jaw is operable wherein by the lever an operating force may be transformed into an engagement force and movement of the jaw.

In a preferred embodiment the drive lever may be capable of receiving a force from the terminal unit when the first and second connectors are mated. Therewith an automatic drive of the counter terminal unit upon mating of the connectors is realised. In the case the second connector drives the terminal unit by its relative movement to the first connector the movement of the terminal unit it also drives its own counter terminal unit by its relative movement towards the first connector.

The second connector may comprise a counter terminal unit. In an advanced embodiment the counter terminal unit may be movable as a whole within the second connector to an end position. Herewith, the parts of the counter terminal unit are brought into an arrangement desired for the mated state of the connectors.

In a beneficial embodiment the counter terminal unit may be movable into its end position by means of the terminal unit, especially when the first and second connectors are mated. In this manner, the counter terminal unit is automatically brought into the arrangement desired for the mated state of the connectors, for example during mating.

The second connector may comprise a short circuit contact shortening at least two terminals of the counter terminal unit when the second connector is in an unmated state. In an enhanced embodiment the shortening is interrupted in the end position of the counter terminal unit. Herewith the shortening of the at least two terminal is interrupted by moving the counter terminal unit into its end position.

In an improved embodiment the counter terminal unit is locked in its end position in an engaged state with the terminal unit. By this construction the counter terminal unit is locked in the engaged state at the same time it is moved into its end position.

In a preferred embodiment at least one of the first and second connectors is floatingly mounted on its carrier component. This allows absorption of misalignment of the connectors with respect to each other when the mating is carried out.

In an improved embodiment the floatingly mounted connector is movable relative to its carrier component in at least two directions in space. Herewith deviations of position can be absorbed.

In an enhanced embodiment the floatingly mounted connector is rotatable relative to its carrier component about at least one axis. This allows the mating of both connectors by a rotational movement towards each other.

In an advanced embodiment the floatingly mounted connector is attached to its carrier component via a resiliently deformable element. If the resiliently deformable element is deformed it applies a load to the floatingly mounted connector towards its initial position.

In a preferred embodiment at least one of the first and second connectors is mounted on its carrier component via an elastomeric element allowing the connector to be moved by a limited amount with respect to its carrier component. Herewith misalignment of both connectors can be absorbed during mating.

### BRIEF DESCRIPTION OF THE DRAWINGS

An embodiment of the present invention is shown in the drawings of which:

FIG. 1 is a perspective view of the inventive electrical connector assembly in an unmated state,

FIG. 2 is a perspective view of a first connector of the inventive connector assembly with its carrier component in an unmated state,

FIG. 3 is a perspective view of a second connector of the inventive connector assembly with its carrier component in an unmated state,

FIG. 4 is a perspective view of the first connector in an unmated state,

FIG. 5 is a side view of the second connector in an unmated state,

FIG. 6 is a top view of the second connector in a unmated state,

FIG. 7 is a side view of the first and second connector with their respective carrier component in an unmated but approached state,

FIG. 8 is a side view of the first and second connector with their respective carrier component in a further approached state in which centring begins,

FIG. 9 is a side view of the first and second connector with their respective carrier component in a mated state,

FIGS. 10 to 12 are sectional views of the first and second connector in an approached and centred state according to section lines X-X, XI-XI and XII-XII in FIG. 6,

FIGS. 13 and 14 are perspective views of the first and second connector in the state shown in FIGS. 10 through 12,

FIGS. 15 to 17 are sectional views in the same cutting planes as in FIGS. 10 through 12 with the first and second connector being further approached and with a terminal unit of the first connector having just started to move,

FIGS. 18 to 20 are sectional views in the same cutting planes as in FIGS. 15 to 17 with the first and second connector further approached and the terminal unit having started to be inserted into the second connector,

FIGS. 21 to 23 are sectional views in the same cutting planes as in FIGS. 18 to 20 with the first and second connector being further approached and a counter terminal unit of the second connector having started to engage the terminal unit,

FIGS. 24 to 26 are sectional views in the same cutting planes as in FIGS. 21 to 23 with the first and second connector being further approached and the counter terminal unit having fully engaged the terminal unit,

FIGS. 27 to 29 are sectional views of the same cutting planes as in FIGS. 24 to 26 with the terminal unit and the counter terminal unit being brought into a final position, and

FIGS. 30 and 31 are perspective views of the first and second connector in the mating state shown in FIGS. 27 to 29.

### DETAILED DESCRIPTION OF THE EMBODIMENTS

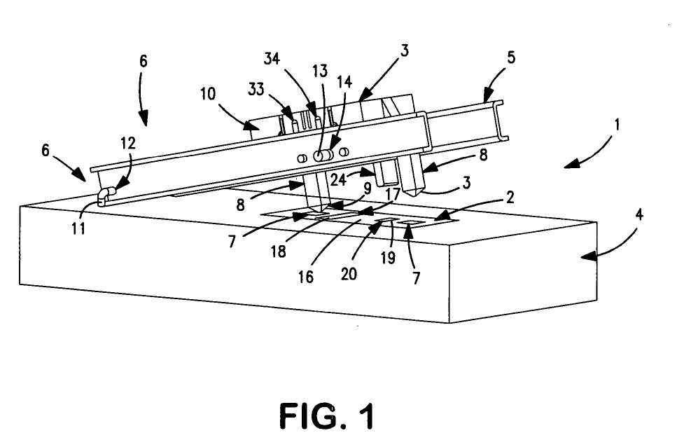

FIG. 1 is a perspective view of the inventive electric connector assembly 1 in an unmated state. The connector assembly 1 comprises a first connector 2 and a second connector 3. The first connector 2 is mounted to a first carrier component 4, and the second connector 3 is mounted to a second carrier component 5.

In the present embodiment the connector assembly 1 serves to electrically connect components of a car seat with components of a car wherein the seat is removable from the car. Components of the car seat may be one or more air bags, entertainment devices such as video or audio units, seat adjustment devices or convenience devices such as massage means. The car components may be energy sources or control units for the seat components.

The first carrier component 4 is, in the present embodiment, a floor module of the car which may be integrated into the floor or panel structure of the car. The second carrier component 5 is a seat module to which the car seat is mounted. Between the car seat and the seat module a translational adjustment device may be provided.

The first and second connectors 2, 3 can be approached relative to each other in a translational and/or rotatory movement. In the present embodiment the first and second carrier components 4, 5 are rotatably engaged with each other by hinge-like means 6.

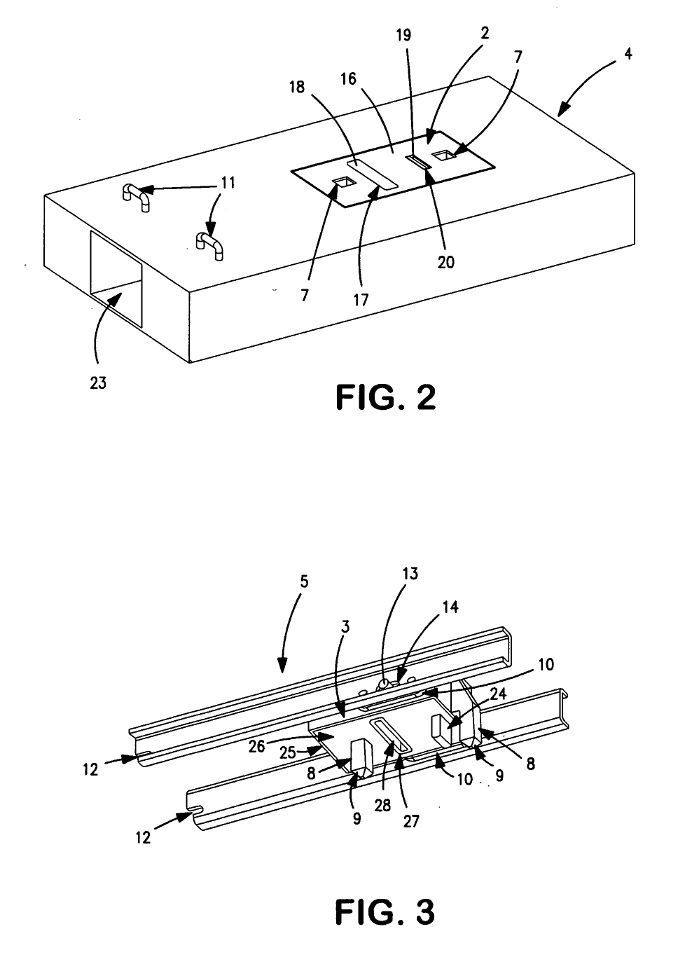

The hinge-like means 6 are constituted by hooks 11 of the first carrier component 4 and cut-outs 12 of the second carrier component 5. The hooks 11 protruding from the first carrier component 4 are shown in more detail in FIG. 2 being a perspective view of the first carrier component 4 and the first connector 2 alone. The cut-outs 12 of the second carrier component 5 are U-shaped and shown in more detail in FIG. 3 being a perspective view of the second carrier component 5 and the second connector 3 alone.

When the first and second carrier components 4, 5 are engaged with each other via the hinge-like means 6 they approach each other in a rotating movement. This corresponds to initially positioning and engaging a car seat at a car floor or panel or other structure and rotating it downwardly.

The first and second connectors 2, 3 comprise corresponding centring and/or guiding means. In the present embodiment the first connector 2 comprises guiding holes 7 adapted to receive guiding and centring rods 8 of the second connector 3. The guiding and centring rods 8 comprise tapering ends 9.

At least one of the first and second connectors 2, 3 is floatingly mounted to its carrier component 4, 5 wherein the connector is moveable in a translational manner in at least two directions and/or rotatably about at least one axis relative to its carrier component. This can be realized by attaching the respective connector via a resiliently deformable element such as an elastomeric element to its carrier component. The movement of the connector relative to its carrier component may be limited.

In the present embodiment the second connector 3 is attached to the second carrier component 5 by means of elastomeric elements 10 on both sides as shown in more detail in FIG. 3.

Therein, the second connector 3 is also directly attached to the second carrier component 5 in a relatively rotatable and translational manner. The second connector 3 comprises pins 13 on both sides. The pins 13 extend into associated holes 14 of the second carrier component 5. The pins 13 can rotate and move in a translational manner within the holes 14. In this embodiment the pins 13 have a circular cross-sectional shape and the holes 14 are of oblong shape as best shown in FIG. 3.

The movement of the pins 13 within the holes 14 is as such, free. By means of the elastomeric elements 10 being relatively fixedly attached to both the second connector 3 as well as the second carrier component 5, reset forces are applied to the second connector 3 when its position differs form an initial position defined by the elastomeric elements 10.

The first connector 2 comprises a terminal unit being moveable with respect to a wall section of the first connector 2. The terminal unit protrudes from the wall section in a first state and is lowered under or aligned with the wall section in a second state. If the terminal unit is in the first state, the first connector 2 comprises a matable profile wherein the terminal unit can be brought into electrical connection with a counter terminal unit of the second connector 3. If the terminal unit is in the second state the pluggable profile is withdrawn.

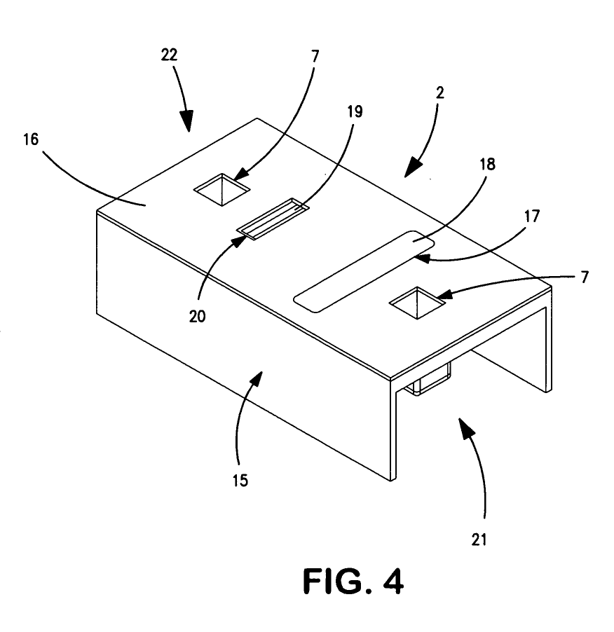

As shown in FIG. 4 the first connector 2 comprises a housing 15 having a substantially U-shaped cross-section. The wall section 16 is a part of the housing 15 facing the second connector 3 in a mated state as becomes clear from FIG. 1. The first connector 2, in particular the wall section 16, comprises a passage 17 through which the terminal unit extends when it is in the first state. In the second state of the terminal unit a cover 18 is positioned within the passage covering the terminal unit, namely in a sealing manner.

The first connector 2 comprising a drive arrangement by means of which the terminal unit is moved relative to the wall section 16. The movement of the terminal unit can be done independently of or dependently upon a mating movement of both connectors 2, 3 towards each other.

The terminal unit can be moved into its first state prior to, during or after bringing the first and second connectors 2, 3 into a position close to each other in which an electrical connection between both may be established. Analogously, the terminal unit may be brought into its second state prior to, during or after separating the first and second connectors 2, 3 away from each other.

The drive arrangement may comprise an electrical motor mechanism, a hydraulic or pneumatic driving mechanism such as gas or hydraulic jacks, or a mechanical gear mechanism such as a lever mechanism. It is possible that the drive arrangement or one of its components, e.g. its lever mechanism, if there is one provided, is driven by an electrical motor mechanism, a pneumatic or hydraulic actuator mechanism, such as gas or hydraulic jacks or by mechanical means. The means for driving the drive arrangement may be associated with the first and / or second connector 2,3.

In the present embodiment the movement of the terminal unit is initiated by pressing an initiation button 19, see FIGS. 1, 2 and 4. The initiation button 19 is accessible through a through hole 20 in the housing 15 of the first connector 2, namely in the wall section 16.

The initiation button 19 of the first connector 2 is operated by an activation finger 24 of the second connector 3. The activation finger 24 protrudes from the second connector 3 in a mating direction of the connectors 2, 3 towards the first connector 2 as best show in FIG. 1. The activation finger 24 is integrally formed with a housing 25 of the second connector 3, namely integrally formed with a counter wall section 26 facing the wall section 16 of the first connector 2 in a mated state of both connectors 2, 3, FIG. 3.

The housing 25 of the second connector, namely the counter wall section 26, compromises an opening 27 through which the terminal unit of the first connector 2 extends in a mated state of both connectors 2, 3. In an unmated state of the second connector 3 a moveable plug 28 is positioned within the opening 27 of the counter wall section 26 in a sealing manner. As shown in FIG. 3 the plug 28 is formed partially hollow but is nevertheless tight with respect to an outside of the second connector 3.

As further shown in FIG. 4 the guiding holes 7 are integrally formed with the housing 15. Both ends of the housing 15 have harness openings 21, 22 corresponding to the U-shaped cross-section of the housing 15. Through the harness openings 21, 22 a not visible harness can be let out of the first connector 2. As shown in FIG. 2 the first carrier component 4 comprises a harness passage 23 through which the harness coming from the first connector 2 may further extend.

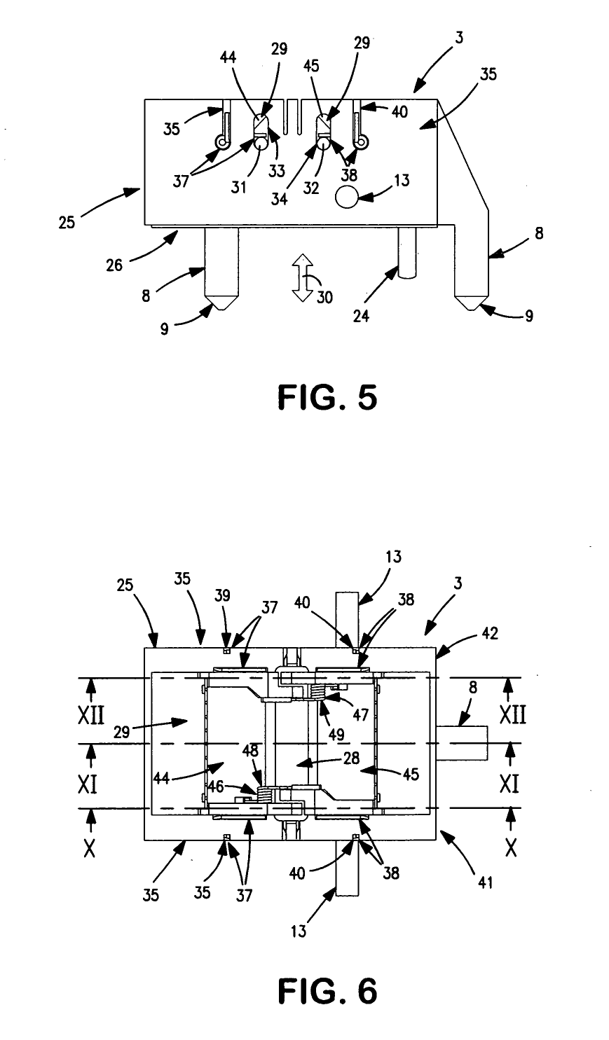

In FIG. 5 the second connector 3 is shown in a side view. The second connector 3 comprises a counter terminal unit 29 capable of being engaged with the terminal unit of the first connector 2. The counter terminal unit 29 is arranged in the inside of the second connector 3 wherein the engagement of both connectors takes place inside the second connector 3.

The counter terminal unit 29 is moveable as a whole within the second connector 3 in a mating direction 30 between an initial position in an unmated state and an end position in a fully mated state. Carrying pins 31, 32 of the counter terminal unit 29 are engaged with oblong leading holes 33, 34 in side walls 35, 36 in the second connector's housing 25. To the counter terminal unit 29 a reset force in the direction of its initial position within the second connector 3 is applied by means of first reset springs 37, 38. The first reset springs 37, 38 are arranged within corresponding slots 39, 40 within the housing 25 and are in engagement with the carrying pins 31, 32 of the counter terminal unit 29.

In the top view of the second connector 3 in FIG. 6 the counter terminal unit 29 is shown in more detail. It becomes clear that both halves 41, 42 of the second connector 3 are, according to a center line 43, similar to each other. For this reason in both halves 41, 42 the same reference numerals are used for each part.

The counter terminal unit 29 comprises two rotatable jaws 44, 45. By means of the jaws 44, 45 the terminal unit of the first connector 2 is engaged in a rotating movement as will be described in more detail below. The jaw 44 shown on the left side in FIG. 6 rotates about the pair of carrying pins 31 one of which being shown on the left side in FIG. 5, and the jaw 45 shown on the right side in FIG. 6 rotates about the pair of carrying pins 32 one of which being shown on the right side in FIG. 5. By means of the jaws 44, 45 the counter terminal unit 29 is capable of engaging with the terminal unit of the first connector 2.

Alternatively, the counter terminal unit 29 may comprise two jaws moveable in a sliding translational manner. These jaws are capable of engaging with the terminal unit of the first connector 2 in a translational movement, e.g. from a direction traverse the mating direction of the connectors 2, 3.

Each jaw 44, 45 comprises a second reset spring 46, 47. The second reset spring 46 of the first jaw 44, i.e. the jaw shown on the left hand side in FIG. 6, is mounted on the first jaw 44 on a pin 48 and is in engagement with both jaws 44, 45. The second reset spring 47 of the second jaw 45, i.e. the jaw shown on the right side in FIG. 6, is mounted on a pin 49 of the second jaw 45 and is in engagement with both jaws 44, 45. Both second reset springs 46, 47 apply forces to the jaws 44, 45 rotating them into a respective initial rotational position.

That is, the second reset springs 44, 47 reset the jaws 44, 45 into an opening position as shown in FIG. 6. Between the opened jaws 44, 45 the plug 28 can be seen.

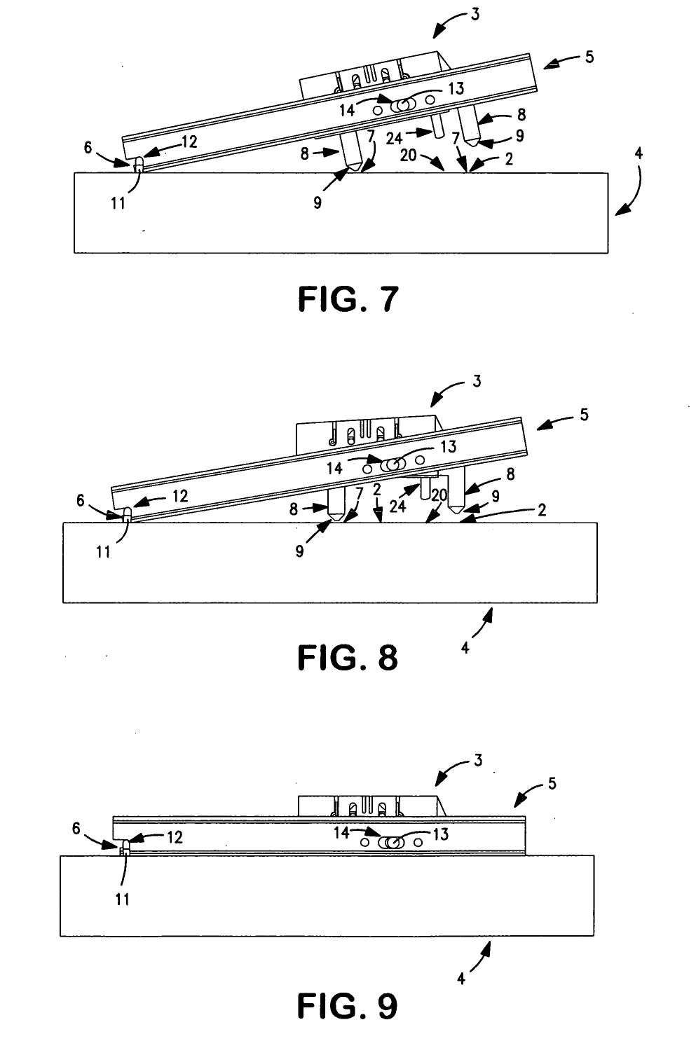

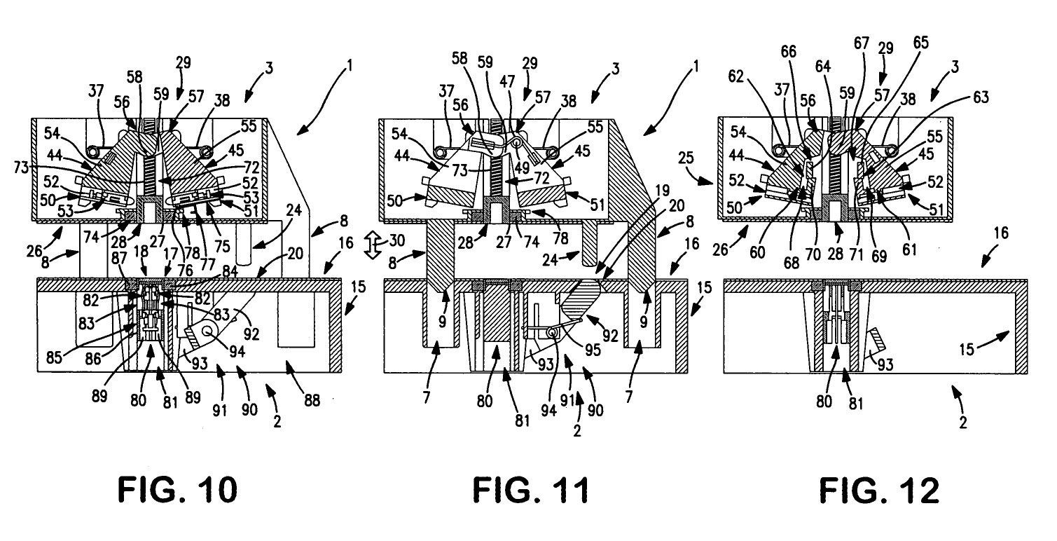

In FIGS. 7 to 8 the mating process is shown in general and will be explained in detail with respect to FIGS. 10 to 31 later.

In FIG. 7 the first and second connectors 2, 3 with their associated first and second carrier components 4, 5 are in the unmated but already approached state as shown in FIG. 1. The second connector 3 and second carrier component 5 now further approach the first connector 2 and first carrier component 4 wherein the centring of the first and second connector 2, 3 with respect to each other begins, FIG. 8.

The tapered tip 9 of the guiding and centring rod 8 shown on the left side in FIG. 8 comes into engagement with the corresponding guiding hole 7. Thereby the second connector 3 is forced to rotate with respect to the second carrier component 5 against the reset forces of the elastomeric element 10 to a more horizontal position than the second carrier component 5 has. That is, absorbing the rotational misalignment of the connectors 2, 3 with respect to each other has begun. In addition, absorbing a translational misalignment of the connectors 2, 3 with respect to each other begins.

The second connector 3 further approaches to the first connector 2. The already engaged guiding and centring rod 8 is further inserted into its corresponding guiding hole 7, and inserting the other guiding and centring rod 8 into its corresponding guiding hole 7 begins. Thereby the first and second connectors 2, 3 are further aligned with respect to each other in rotational and translational aspect.

During alignment the pins 13 of the second connector 3 rotate and move within their associated holes 14 in the second carrier component 5. In this way the second connector 3 can carry out the rotational and translational movement with respect to the second carrier component 5.

When the tapered tips 9 of both guiding and centring rods 8 are inserted into the guiding holes 7 of the first connector 2, both connectors 2, 3 are generally aligned with each other in a rotational and translational aspect. Thereafter the activation finger 24 comes into contact with the initiation button 19 of the drive arrangement of the first connector 2 and pushes it. This initiates the movement of the terminal unit from its second state into its first state. During this movement the terminal unit extends through the passage 17 of the wall section 16 as well as through the opening 27 of the counter wall section 26 and is inserted into the inside of the second connector 3. Upon insertion the counter terminal unit 29 engages with the terminal unit by rotating the jaws 44, 45 towards the terminal unit.

If the engagement of terminal unit and counter terminal unit 29 is completed the counter terminal unit 29 moves as a whole within the second connector 3 to its end position remaining engaged with the terminal unit. Now the mating of both connectors 2, 3 is completed, FIG. 9.

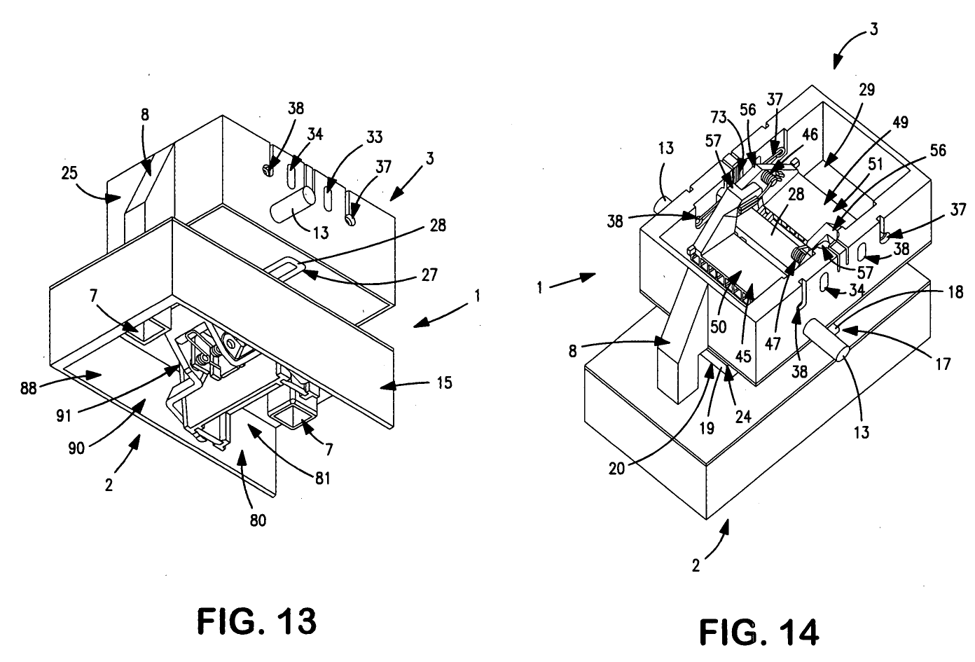

FIGS. 10 to 12 are cross-sectional views of the first and second connector 2, 3 according to lines X-X, XI-XI and XII-XII in FIG. 6. FIGS. 13 and 14 are perspective views of the first and second connectors 2, 3 in the stage when in the state shown in FIGS. 10 to 12.

In FIGS. 10 to 14 the jaws 44, 45 are shown in the same position as in FIGS. 5 and 6. Each jaw 44, 45 comprises a base portion 50, 51 with slots 52 in which terminals 53 are received in a manner protruding from the base portion 50, 51 towards the respective other jaw 45, 44. Each jaw further comprises a middle portion 54, 55 and a drive lever 56, 57. Each drive lever 56, 57 has a cam section 58, 59.

The jaws 44, 45 are driven by applying a force to the respective drive lever 56, 57, namely to the respective cam section 58, 59. This rotates the jaws 44, 45 in a manner in which the base portions 50, 51 approach each other. The force applied to the drive levers 56, 57 needs to be bigger than the reset force of the second reset springs 46, 47.

Moving the counter terminal unit 29 into its end position is prevented in this position of the jaws by movement control mechanisms 60, 61 as shown in FIG. 12. Each movement control mechanism 60, 61 comprises a movement control recess 62, 63 and a corresponding engagement profile 64, 65 capable of being moved relative to the movement control recess 62, 63 and at least partially within this movement control recess 62, 63. The movement control recess is of an angled shape and comprises an insertion section 66, 67 as well as a slide section 68, 69.

As long as the engagement profile 64, 65 is positioned within the insertion section 66, 67 a movement of the counter terminal unit 29 into its end position is prevented. Rather, the engagement profile 64, 65 abuts against the top of a sliding wall 70, 71 defining at one side the width of the insertion section 66, 67. The sliding wall 70, 71 also defines one side of the slide section 68, 69. The top of the sliding wall 70, 71 has a curved profile enabling the engagement profile 64, 65 to slide thereon more easily.

If the engagement profile 64, 65 has reached the access to the slide section 68, 69, maybe by sliding on the top of the sliding wall 70, 71, moving the counter terminal unit 29 into its end position is possible. At the same time, a rotational movement of the jaws 44, 45 is locked by the side walls of the slide section 68, 69.

In the present embodiment each jaw 44, 45 is associated with one movement control mechanism 60, 61. The respective movement control recess 62, 63 is formed in the jaw 44, 45. The engagement profile 64, 65 provided at the housing 25 of the second connector 3, is integrally formed with its respective side wall 35.

As further shown in FIGS. 10 to 12 the plug 28 is moveable within a counter cavity 72 between a position sealingly closing the opening 27 and positions in which it is in engagement with the drive levers 56, 57 of the jaws 44, 45. In the counter cavity 72 a third reset spring 73 is provided. The third reset spring 73 applies a resetting force to the plug 28 in the direction of the plug sealingly closing the opening 27.

In the opening 27 a sealing member 74 is provided. By engaging the sealing member 74 the plug 28 sealingly covers the opening 27.

The second connector 3 comprises at least one short circuit contact 75 shorting at least two terminals 53 of the counter terminal unit 29 when the second connector 3 is in an unmated state, FIG. 10. More particularly, the short circuit contact 75 comprises at least one contact section 76 which can be removably brought into contact with at least one of the associated terminals 53 of the counter terminal unit 29. The contact section 76 is in its removed position when the counter terminal unit 29 is in its end state so that the shorting is interrupted while the contact section 76 contacts said terminal 53 in the unmated state of the second connector so that a short circuit is established.

The short circuit contact 75 may be attached to one of the counter terminal unit 29 and may be engaged with the other thereof 25, 29 if the counter terminal unit 29 is in its end position. In the present invention the short circuit contact 75 is attached to a jaw 45 of the counter terminal unit and comprises a hook section 77. The hook section 77 can be brought into engagement with the housing 25, namely with a counter hook section 78 thereof. Upon bringing the jaw 45 towards the other jaw 44, i.e. in a direction for engaging the terminal unit of the first connector 2, the hook section 77 and the counter hook section 78 are engaged with each other. If the counter terminal unit 29 is then moved as a whole into its end position the contact section 76 is moved away relatively to the terminal 53 whereby the short circuit is interrupted.

It is noted that the terminal 53 of the counter terminal unit 29 can be contacted at two different locations. One location is at the side of the terminal 53 and one at the extremity of the terminal 53. At the location at the side the terminal 53 is contacted by the short circuit contact 75, and at the location at the extremity the terminal 53 is brought into contact with a corresponding terminal of the terminal unit of the first connector 2.

In the following the first connector 2 is shown in FIGS. 10 to 12 and is further described. The first connector 2 comprises the terminal unit 80. The terminal unit 80 being moveable relative to the wall section 16 and is slidingly guided within a cavity 81 of the first connector 2. The terminal unit 80 comprises terminals 82 which are accessible through side holes 83 of the terminal unit. The cover 18 is attached to a leading portion of the terminal unit 80. At a rear portion 85 adjacent the side holes 83 the terminal unit 80 comprises a surrounding wall 86.

A sealing member subsequently named as first sealing member 87 is provided at the passage 17 through which the terminal unit 80 extends in its first state. In the second state of the terminal unit 80 as shown in FIGS. 10 to 12 the passage 17 is sealingly covered as the cover 18 is in sealing engagement with the first sealing member 87.

It is possible that the leading end 84 of the terminal unit 80 is cover-like formed and is in sealing engagement with the first sealing member 87 in the second state so that this engagement alternatively or in addition seals the passage 17.

In its retracted position in the second state the terminal unit 80 is protected from damaging mechanical influences as well as from the worst of the dirt. Such influences may occur on a floor of a car onto which the first connector 2 may be mounted. By sealingly covering the passage 17 the terminal unit 80 is in its second state also protected from the influences of an aggressive environment, e.g. protected from the influences of finer dirt and moisture as they may be present on a car floor.

In this way, an inside 88 of the first connector 2 or at least the cavity 81 may be considered as a protection room with respect to the mentioned influences.

If the terminal unit 80 is in its first state in which it protrudes from the wall section 16 the surrounding wall 86 is in sealing engagement with the first sealing member 87. Accordingly, dirt and/or moisture are prevented from entering the cavity 81 between the terminal unit 80 and the passage 17.

The surrounding wall 86 of the terminal unit 80 is also in sealing engagement with the sealing member 74 of the second connector 3, hereafter called second sealing member 74. In this manner in the mated state dirt and/or moisture are prevented from entering the cavity 81 between the terminal unit 80 and the passage 17 as well as from entering the counter cavity 72 between the opening 20 and the terminal unit 80. Accordingly, the cavity 81 remains clean and the terminal unit 80 comes back into a clean environment when brought into its second state. In other words the protection room of the first connector 2 is sealed against the outside also if the terminal unit 80 is in the second state.

The first connector 2 comprises the drive arrangement by means of which the first terminal unit is moved relatively to the wall section 16. The movement is effected via the drive arrangement upon a relative mating and/or unmating movement of the first and second connector. Therein, the drive arrangement transforms the relative mating and/or unmating movement into the movement of the terminal unit 80.

The drive arrangement can be realized by means of a motor drive and/or mechanical means. The drive arrangement may operate upon pressing the initiation button 19 as shown in FIGS. 1, 2 and 4.

In the present embodiment the drive arrangement is a gear mechanism, in particular it is a lever mechanism 90, FIGS. 10 to 13. The lever mechanism 90 comprises a lever 91 having a first and a second arm 92, 93. A part of the first arm 92 is the initiation button 19. That is, by pressing the initiation button 19 the lever 91 rotates about a lever pin 94 provided on the housing 15. By pressing the initiation button 19 the force of a fourth reset spring 95 has to be overcome. The fourth reset spring 95 is in engagement with the first arm 92 and with the housing 15.

The second arm 93 of the lever 91 is in rotational engagement with the terminal unit 80. Moving the first arm 92 into the inside 88 of the first connector 2, i.e. by pressing the initiation button 19, leads to moving the terminal unit 80 towards an outside, i.e. towards its first position.

The lever 91 is rotated in the opposite direction by means of the fourth reset spring 95 if the operating force onto the initiation button 19 is taken away. That is, by means of the force reset spring 95 the terminal unit 80 is moved back into its second state and the first arm 92 is moved back towards an outside of the first connector 2.

In the following the processes within the first and second connectors 2, 3 during mating is described in detail with respect to FIGS. 10 to 14. In the state shown in FIGS. 10 to 14 the first and second connector 2, 3 are already aligned with respect to each other in a rotational and translational manner. As shown in FIG. 11 the tapered tips 9 of the guiding and centring rods 8 are fully inserted into the guiding holes 7 but the activation finger 24 is still distanced from the first connector 2. The terminal unit 80 is in it second state with the passage 17 being sealingly covered. The lever mechanism 90 has a corresponding position with the initiation button 19 being positioned within the through hole 20 in alignment with the wall section 16.

In the second connector 3 the counter terminal unit 29 is in its initial state. The jaws 44, 45 are in an opened position with their base portions 50, 51 being rotated away from each other. The opening 27 is sealingly covered by means of the plug 28. The short circuit of the at least two terminals 53 of the counter terminal unit 29 is established with the contact section 76 abutting against at least one terminal 53. The hook section 77 is disengaged with its counter hook section 78.

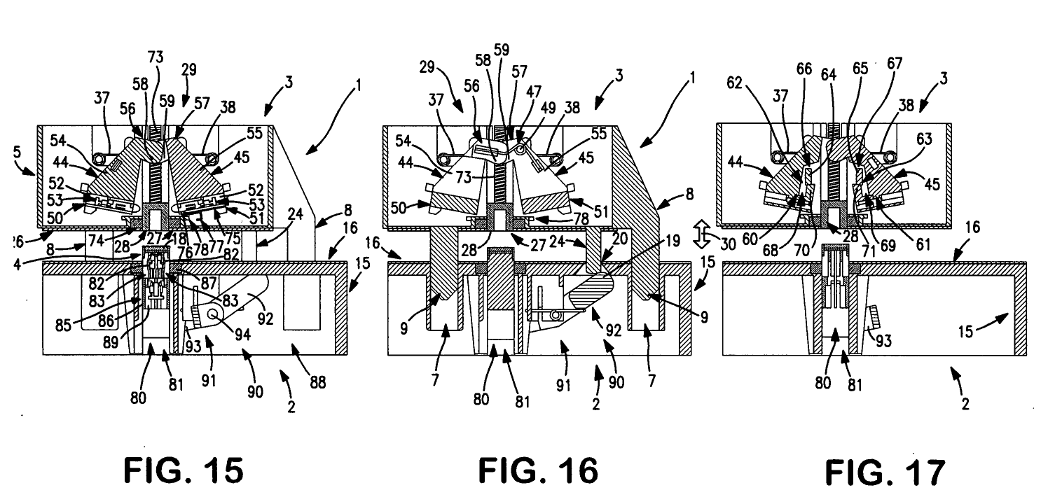

In the state shown in FIGS. 15 to 17 the first and the second connector 2, 3 further approach each other wherein the activation finger 24 partially extends through the through hole 20 and has begun to press down on the activation button 19. The lever 91 is rotated about the lever pin 94 against the force of the fourth reset spring 95 whereby the terminal unit 80 has started to move towards its first protruding position. However, the terminal unit 80 is still distanced from the plug 28 so that the elements within the second connector 3 are in the same positions as shown in FIGS. 10 to 14.

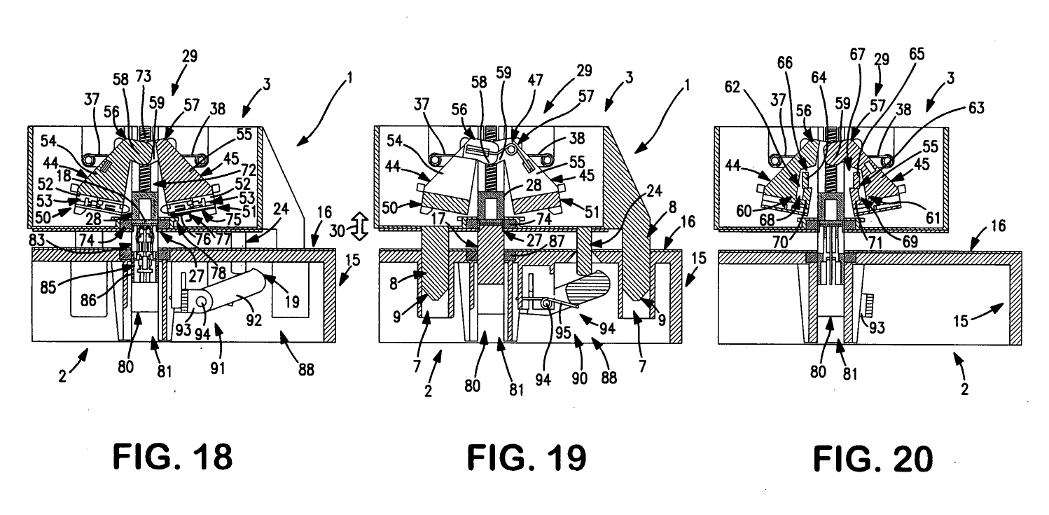

Turning now to FIGS. 18 to 20 the connectors 2, 3 are shown in a further approached state. The activation finger 24 has pushed the first arm 92 further into the inside 88 of the first connector 3. The lever 91 is further rotated against the force of the fourth reset spring 94 whereby the terminal unit 80 protrudes further from the wall section 16.

The terminal unit 80 has started to push the plug 28 into the counter cavity 72 against the force of the third reset spring 73. Thereby, the cover 18 is just in sealing engagement with the second sealing member 74. That is, the terminal unit 80 partially extends through the opening 27. The position of the elements associated with the counter terminal unit 29 is still the same as shown in FIGS. 10 to 14.

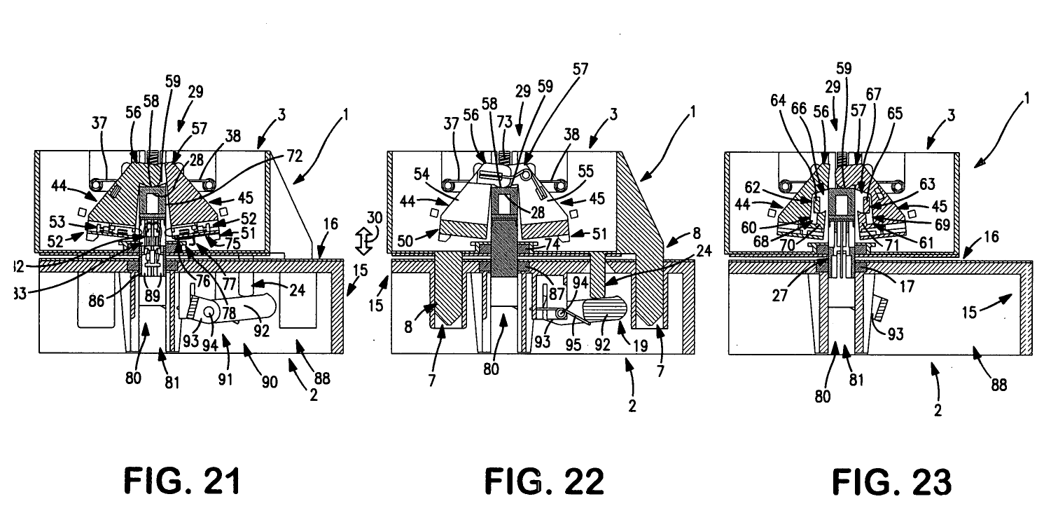

Reference is made to the state shown in FIGS. 21 to 23. The connectors 2, 3 further approach each other so that the activation finger 24 has further rotated the lever 91 wherein the terminal unit 80 further protrudes from the wall section 16 and is further inserted into the counter cavity 72. The surrounding wall 86 of the terminal unit 80 is in sealing engagement with the first and second sealing member 87, 74. In this way the cavity 81 as well as the counter cavity 72 are sealed form the influences of an aggressive environment. Via slots 89 in which the terminals 82 of the terminal unit are arranged, the counter cavity 72 and the cavity 81 are connected to each other in a manner protected from the influences of an aggressive environment. That is, the protective rooms of both connectors 2, 3 are connected in said manner.

The terminal unit 80 is so far inserted into the slot 72 that the plug 28 abuts against the cam sections 58, 59 of the drive levers 56, 57 of the jaws 44, 45. That is, the drive levers 56, 57 receive a force from the terminal unit 80 so that the jaws rotate towards each other against the force of the second reset springs 46, 47. The movement of the counter terminal unit 29 into its end position is prevented in this state as the engagement profiles 64, 65 are still in the insertion sections of the movement recesses 62, 63 and slide over the top of the sliding walls 70, 71.

By the rotation of the jaws 44, 45 the counter terminal unit has begun to engage the terminal unit 80. That is, the terminal unit is engaged from a direction traverse the mating direction 30. The tips of the terminals 53 of the counter terminal unit 29 just enter into the side holes 83 of the terminal unit 80.

The contact section 76 of the short circuit contact 75 still abuts against a side of the at least one terminal 53 of the counter terminal unit 29 and the hook section 77 is still disengaged with the counter hook section 78.

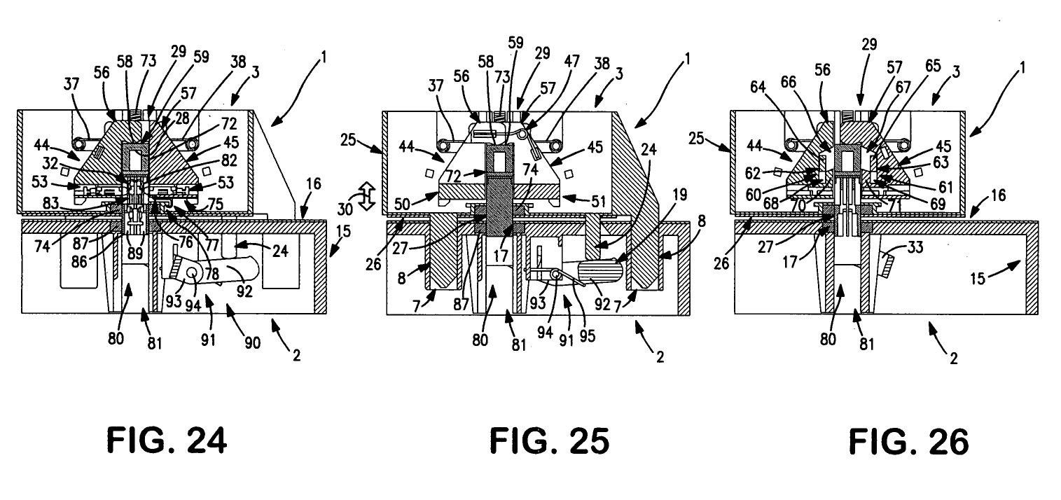

In FIGS. 24 to 26 the connectors 2, 3 further approach each other. By effect of the activation finger 24 the lever 91 is further rotated and the terminal unit 80 is further inserted into the slot 72 with the surrounding wall 86 being in engagement with the first and second sealing member 87, 74. The jaws 44, 45 are rotated towards each other at a maximum. The terminals 53 of the counter terminal unit29 press against the terminals 82 of the terminal unit 80.

The engagement profiles 64, 65 are now in a position within their respective movement control recess 62, 63 that they may enter the slide sections 68, 69.

The contact section 76 of the short circuit contact 75 still abuts against the sides of the at least one terminal 53 of the counter terminal unit 29 while the hook section 77 is now engaged with its counter hook section 78.

The counter terminal unit 29 is now ready to move as a whole within the second connector 3 into its end position.

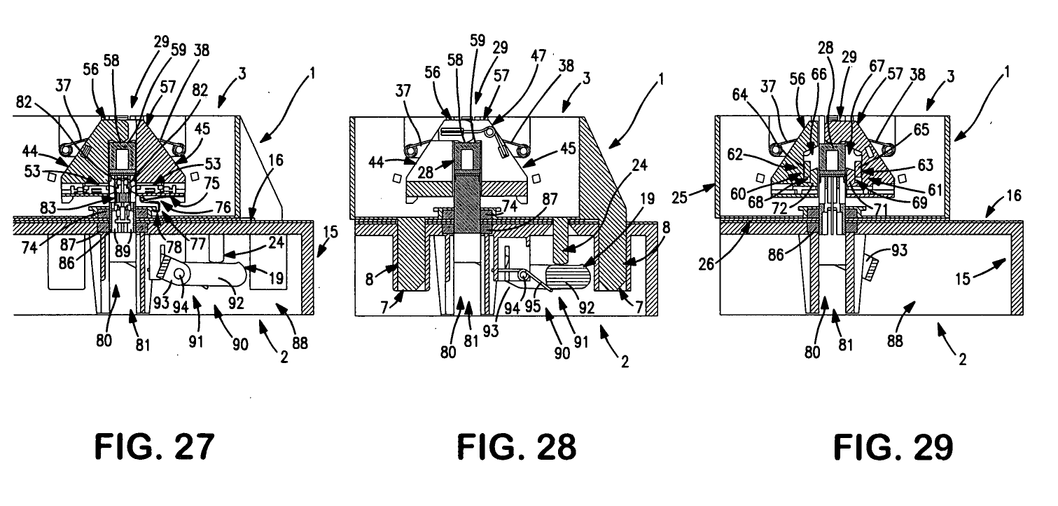

In the state in FIGS. 27 to 29 the first and the second connectors 2, 3 are fully mated with each other. The wall section 16 and the counter wall section 26 of the second connector 3 abut against each other. The activation finger is introduced at a maximum into the inside 88 of the first connector 2, wherein the lever 91 is rotated at a maximum with the terminal unit 80 being in its first position. Also the guiding and centring rods 8 are inserted into the guiding holes 7 at a maximum.

By the final rotation of the lever 91 the terminal unit 80 was introduced at a maximum into the counter cavity 72 of the second connector. The force therefore applied to the counter terminal unit 29 has moved the counter terminal unit as a whole into its end position within the second connector 3. Thereby, the engagement profiles 64, 65 are at least partially slid into the slide sections 68, 69 due to the relative movement of the movement control recesses 62, 63 to the engagement profiles 64, 65. In this position the jaws 44, 45 are prevented from rotating as the engagement profiles 64, 65 abut against the side walls of the slide section 68, 69. The movement of the counter terminal unit 29 as a whole into its end position was carried out against the forces of the first reset springs 37, 38.

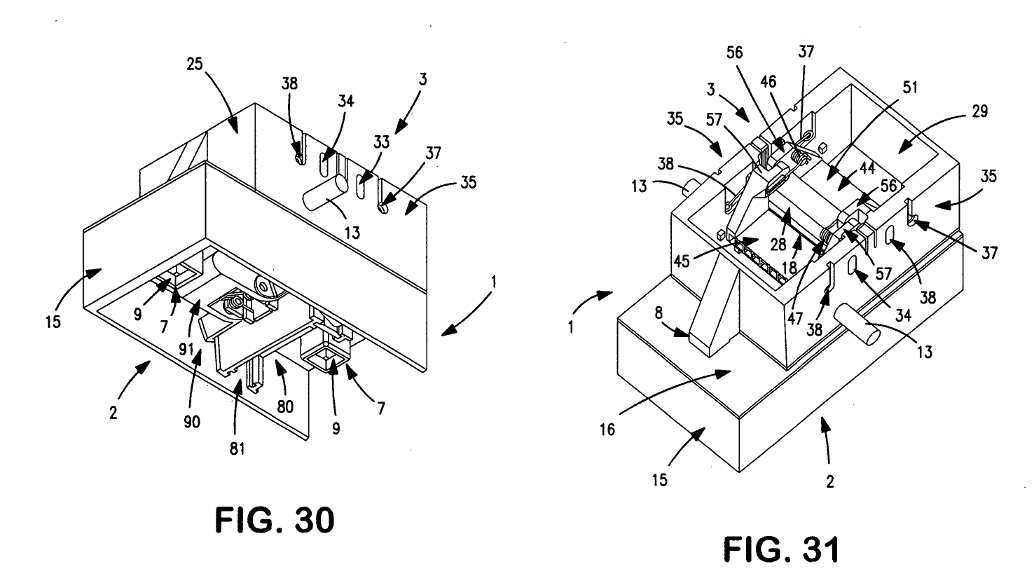

FIGS. 30 and 31 are perspective views of the mating state as shown in FIGS. 27 to 28.

The unmating process takes place in the opposite order. By moving the connectors 2, 3 away from each other the activation finger 24 is withdrawn. This allows the reset springs 37, 38, 46, 47, 73, 95 to move the elements back into their initial positions.

1.-37. (canceled)

38. An electrical connector assembly comprising:
a first connector and a second connector;
a housing in the first connector having a wall section; and
a terminal unit protruding from the wall section of the first connector to enable the first connector to be mated with the second connector, the terminal unit being movable with respect to the wall section;
wherein the terminal unit protrudes from the wall section in a first state and the terminal unit is lowered under or aligned with the wall section in a second state;
wherein the first connector comprises a drive arrangement being capable of moving the terminal unit relative to the wall section;
wherein the drive arrangement comprises a lever mechanism; and
wherein the second connector comprises an activation finger protruding from the second connector in a mating direction towards the first connector, wherein the activation finger drives the lever mechanism.

39. The electrical connector assembly according to claim 38, wherein the second connector comprises a counter terminal unit capable of being engaged with the terminal unit of the first connector inside the second connector.

40. The electrical connector assembly according to claim 39, wherein the second connector comprises a counter terminal unit capable of being engaged with the terminal unit of the first connector from a direction traverse a mating direction of the connectors.

41. The electrical connector assembly according to claim 39, wherein the counter terminal unit engages the terminal unit between a pair of rotatable jaws.

42. The electrical connector assembly according to claim 40, wherein the counter terminal unit comprises at least one rotatable jaw capable of engaging the terminal unit in a rotating movement.

43. The electrical connector assembly according to claim 40, wherein the counter terminal unit comprises at least one jaw capable of engaging the terminal unit in a translational movement.

44. The electrical connector assembly according to claim 43, wherein each jaw comprises a drive lever wherein a force applied to the drive lever moves the jaw.

45. The electrical connector assembly according to claim 44, wherein the drive lever is capable of receiving a force from the terminal unit when the first and second connectors are mated.

46. The electrical connector assembly according to claim 45, wherein the second connector comprises a counter terminal unit which is moveable within a second connector to an end position.

47. The electrical connector assembly according to claim 46, wherein the counter terminal unit is moveable into its end position by means of the terminal unit when the first and second connectors are mated.

48. The electrical connector assembly according to claim 47, wherein the second connector comprises a short circuit contact shorting at least two terminals of the counter terminal unit when the second connector is in an unmated state, the shorting being interrupted in the end position of the counter terminal unit.

49. The electrical connector assembly according to claim 48, wherein the counter terminal unit is locked in its end position in an engaged state with the terminal unit.

50. The electrical connector assembly according to claim 49, wherein at least one of the first and second connectors is floatingly mounted on a carrier component.

51. The electrical connector assembly according to claim 50, wherein the floatingly mounted connector is moveable relative to its carrier component in at least two directions.

52. The electrical connector assembly according to claim 50, wherein the floatingly mounted connector is rotatable relative to its carrier component about at least one axis.

53. The electrical connector assembly according to claim 51, wherein the floatingly mounted connector is attached to its carrier component by an elastomeric element.

54. The electrical connector assembly according to claim 52, wherein at least one of the first and second connectors is mounted on its carrier component via an elastomeric element allowing the connector to be moved by a limited amount with respect to its carrier component.

55. The electrical connector assembly according to claim 38, wherein the first connector comprises a passage through which the terminal unit extends in the first state and which is sealingly covered when the terminal unit is in the second state.

56. The electrical connector assembly according to claim 55, wherein the terminal unit extends through the passage in a sealed manner in the first state.

57. The electrical connector assembly according to claim 56, wherein the second connector comprises an opening through which the terminal unit extends in a sealed manner when the connectors are in a mated position.

58. The electrical connector assembly according to claim 57, wherein the terminal unit comprises a surrounding wall extending through the passage and the opening in a sealed manner.

59. The electrical connector assembly according to claim 38, wherein the first connector comprises a protection room in which the terminal unit is received in the first state with the protection room being sealed against the outside of the first connector when the terminal unit is in the first state.

60. The electrical connector assembly according to claim 59, wherein the protection room is sealed against the outside when the terminal unit is in the second state.

61. The electrical connector assembly according to claim 38, wherein movement of the terminal unit is effected by the drive arrangement during a relative mating movement of the first and second connectors.

62. The electrical connector assembly according to claim 38, wherein the drive arrangement transforms the relative mating movement of the first and second connectors into the movement of the terminal unit relative to the wall section.

63. An electrical connector assembly, comprising:
a first connector having a wall section;
a second connector having a protruding activation finger;
a terminal unit carried by the first connector, the terminal unit being movable with respect to the wall section and operable between a first state where the terminal unit protrudes from the wall section and a second state where the terminal unit does not protrude from the wall section; and
a lever carried by the first connector, the lever being configured for interaction with the activation finger and being configured to cause movement of the terminal unit toward the first state when the lever is moved by the activation finger.

64. The electrical connector assembly according to claim 63, further comprising:
a passage formed in the first connector, the passage being configured to house the terminal unit when the terminal unit is in the second state and the passage being configured to at least partially house the terminal unit when the terminal unit is in the first state.

65. The electrical connector assembly according to claim 64, wherein the passage remains sealed from the outside of the first connector while still allowing movement of the terminal unit.

66. The electrical connector assembly according to claim 63, wherein interaction between the activation finger and the lever occur during a mating action between the first connector and the second connector and wherein upon completion of the mating action, at least a portion of the terminal unit is received within the second connector.
